(19) United States
(12) Patent Application Publication
(10) Pub. No.: US 2008/0181316 A1
(43) Pub. Date: Jul. 31, 2008

(54) Partitioned Signal and Power Transfer Across an Isolation Barrier

(76) Inventors: Philip John Crawley, Sacramento, CA (US); Sajol Ghoshal, El Dorado Hills, CA (US); David E. Bliss, Loomis, CA (US); Timothy A. Dhuyvetter, Arnold, CA (US)

Correspondence Address: KOESTNER BERTANI LLP, 2192 Martin St., Suite 150, Irvine, CA, 92612, US

(21) Appl. No.: 11/627,345

(22) Filed: Jan. 25, 2007

(51) Int. Cl. H04B 3/54

(52) U.S. Cl. 375/258

(57) ABSTRACT

A method for transferring power and information across an isolation barrier comprises transferring power across a power transfer isolation barrier between a primary circuit and a secondary circuit while maintaining isolation between the primary and secondary circuits, and transferring data between the powered system and the isolated system across a communication isolation barrier that is distinct from the power transfer isolation barrier.

### BACKGROUND

Various communications, medical, computing, industrial, and other systems implement isolation barriers to electrically isolate sections of electronic circuitry. An isolator is a device that can transfer a signal between sections of electronic circuitry while maintaining electrical isolation between the sections.

A typical conventional design attains isolation, for example, by connecting to a communication channel through a transformer. The transformer provides isolation both for surge and galvanic isolation. Power can be transmitted on the line through the transformer.

### SUMMARY

According to an embodiment of a network system, a method for transferring power and information across an isolation barrier comprises transferring power across a power transfer isolation barrier between a primary circuit and a secondary circuit while maintaining isolation between the primary and secondary circuits, and transferring data between the powered system and the isolated system across a communication isolation barrier that is distinct from the power transfer isolation barrier.

### BRIEF DESCRIPTION OF THE DRAWINGS

Embodiments of the invention relating to both structure and method of operation may best be understood by referring to the following description and accompanying drawings:

FIG. 1 is a schematic block diagram illustrating an embodiment of a communication system that partitions signal communication and power transfer across an isolation barrier;

FIG. 2 is a schematic block diagram showing an embodiment of a communication device that is adapted for communicating across an isolation barrier;

FIG. 3 is a schematic block diagram that depicts an embodiment of a transmitter system in a communication system and shows an example of isolation partitioning lines for a digital isolation barrier in FIG. 2;

FIG. 4 is a schematic block diagram illustrating an embodiment of a communication system that includes one or more isolation barriers;

FIG. 5 is a schematic block diagram that depicts an embodiment of a Serial Gigabit Media Independent Interface (SGMII) core;

FIG. 6 is schematic block diagram showing possible locations for inserting an isolation barrier;

FIG. 7 is a schematic block diagram illustrating an embodiment of a communication system that includes multiple isolation barriers;

FIG. 8 is a schematic block diagram showing another embodiment of a communication system that includes an isolation barrier;

FIG. 9 is a schematic block diagram that depicts an embodiment of a communication system that includes an isolation barrier;

FIG. 10 is a schematic block diagram showing another embodiment of a communication system that implements another isolation barrier;

FIGS. 11A, 11B, and 11C are multiple flow charts illustrating embodiments of a method for transferring power across an isolation barrier; and

FIG. 12 is a flow chart showing an embodiment of a method for transferring power and information across an isolation barrier.

### DETAILED DESCRIPTION

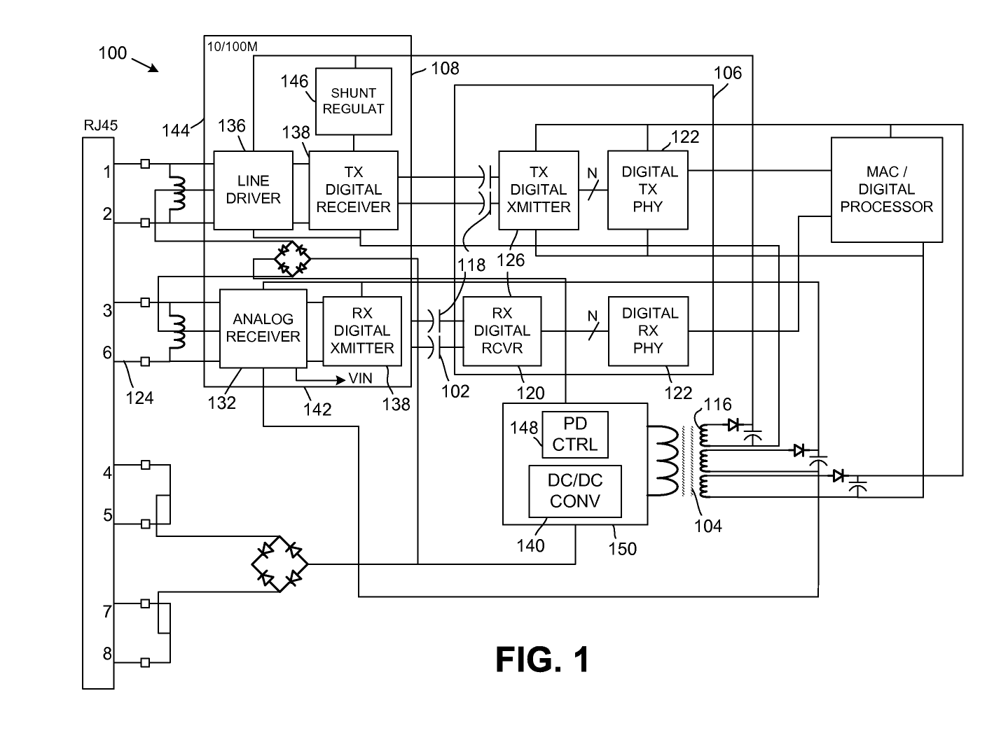

Referring to FIG. 1, a schematic block diagram depicts an embodiment of a communication system 100 that partitions signal communication and power transfer across an isolation barrier for a 10/100 M Ethernet application. The communication system 100 comprises a secondary circuit 106 and a primary circuit 108 that is adapted to communicate with the secondary circuit 106. A power transfer isolation barrier 104 is coupled between the secondary circuit 106 and the primary circuit 108 and is configured to transfer power while maintaining isolation between the secondary 106 and primary 108 circuits. A communication isolation barrier 102 distinct from the power transfer isolation barrier 104 is coupled between the secondary circuit 106 and the primary circuit 108 and is configured to transfer data between the secondary circuit 106 and the primary circuit 108.

In the illustrative embodiment, the second circuit 108 can comprise a communication channel 122 configured for coupling to a network line 124 to communicate information, a transmission and receiver circuit 120 coupled to the communication channel 122 for transmitting and/or receiving the communicated information, and a digital interface 126 coupled to the transmission and receiver circuit 120 and configured to communicate digital information over the communication isolation barrier 102. The primary circuit 108 can further comprise a DC-DC converter primary circuit 140 coupled to the transmission and receiver circuit 120 and the digital interface 126 which is configured to transfer power over the power transfer isolation barrier 104. The primary circuit 108 can comprise an application unit 144 that transmits and/or receives the communicated information, a digital interface 138 coupled to the application unit 144 that can communicate digital information over the communication isolation barrier 102, and a DC-DC converter primary circuit 136 coupled to the application unit 144 and the digital interface 138. The DC-DC converter primary circuit 136 is configured to transfer power over the power transfer isolation barrier 104.

Suitable DC-DC converter components can be full-bridge or half-bridge rectified DC-DC converters enabling minimization of common-mode noise. Other DC-DC converters can also be flyback converters, forward converters, or any other suitable type of converter. In communication system 100 a multiple output flyback converter is illustrated. A synchronous full-bridge or half-bridge rectified DC-DC converter can improve the efficiency and reduce common-mode noise.

The secondary circuit transmission and receiver circuit 120 and digital interface 126, and the primary circuit application unit 144 and digital interface 138 can be configured to pass feedback control signals over the digital isolation barrier 102 that control transfer of power over the power transfer isolation barrier 104.

In other embodiments, the communication system 100 can be configured as a Power-over-Ethernet (PoE) system. For example, the secondary circuit 106 can comprise a power connection that supplies power to the DC-DC converter secondary circuit 140, a Tconnect and powered device (PD) controller 148 coupled to the DC-DC converter secondary circuit 140, and a power extraction circuit 150 coupled to the secondary circuit digital interface 126 that is configured to controllably transfer additional power over the power transfer isolation barrier 104. The primary circuit 108 can further comprise a power connection that supplies power from the DC-DC converter primary circuit 136 to an application system 144 and a feedback digitizer coupled between the primary circuit digital interface 138 and the DC-DC converter primary circuit 136 that is configured to control power transfer over the power transfer isolation barrier 104 using feedback control.

In the various illustrative embodiments, the secondary circuit and primary circuit digital interfaces 126, 138 can be a serializer/deserializer (SERDES) interface, a Serial Gigabit Media Independent Interface (SGMII), or any other suitable interface.

In some embodiments, the communication isolation barrier 102 can form an isolated transmission pathway that comprises one or more capacitors and the power transfer isolation barrier 104 can form an isolated power transfer pathway comprising a power transformer. The communication isolation barrier 102 can be a capacitive isolation barrier, an electrostatic isolation barrier, a transformer isolation barrier, a serializer/deserializer (SERDES) isolation barrier, a magnetic isolation barrier, an optical isolation barrier, a thermal isolation barrier, a resistive isolation barrier, a piezoelectric isolation barrier, or any other suitable isolation barrier. The power transfer isolation barrier 104 can be a power transformer, a high-voltage switched-capacitor power circuit, a piezoelectric ceramic power converter, a power transfer device, or other suitable device.

The SERDES is similar to a digital isolator, but typically depends on high-frequency modulation and the frequency of modulation to communicate signals. In contrast, a basic digital isolator communicates based on signal edges enabling data communication to very low frequencies, down to DC. Many different examples of digital isolators can be implemented, for example MLT-3 encoder that can be a two-bit interface or a three level interface and enables simple encoding.

The power transfer isolation barrier 104 in some implementations can be configured to transfer power from the secondary circuit 106 to the primary circuit 108 with the communication isolation barrier 102 configured to communicate digital communication signals bidirectionally between the secondary circuit 106 and the primary circuit 108.

The power transfer isolation barrier 104 in other implementations can be configured to transfer power from the primary circuit 108 to the secondary circuit 106 with the communication isolation barrier 104 configured to communicate digital communication signals bidirectionally between the secondary circuit 106 and the primary circuit 108.

The illustrative communication system 100 can be implemented in a Power-over-Ethernet (PoE)-type application that includes a transceiver that can be a DC-DC converter 140 and transformer 104 and has feedback to the line side with the digital transmitter and receiver.

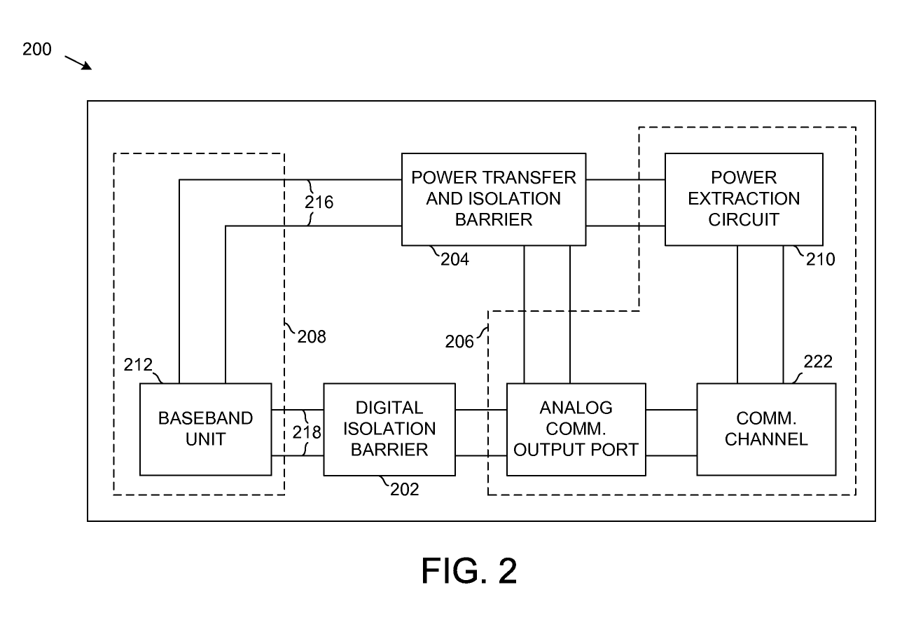

Referring to FIG. 2, a schematic block diagram illustrates an embodiment of a communication device 200 that is adapted for communicating across an isolation barrier. The communication device 200 comprises a powered system 206 and an isolated system 208 which are configured to bidirectionally communicate with the powered system 206. A power transfer isolation barrier 204 is configured to transfer power while maintaining isolation between the powered system 206 and the isolated system 208. A digital isolation barrier 202 configured to communicate digital communication signals between the powered system 206 and the isolated system 208. The power transfer isolation barrier 204 is distinct from the digital isolation barrier 202.

The illustrative power transfer isolation barrier 204 is configured to partition a power transfer pathway 216 between the powered system 206 and the isolated system 208 independently of partitioning of a communication pathway 218.

Similarly, in some embodiments the digital isolation barrier 202 can be configured to partition a communication pathway 218 between the powered system 206 and the isolated system 208 independently of partitioning of a power transfer pathway 216.

In some embodiments, the power transfer isolation barrier 204 can be configured to transfer power from the powered system 206 to the isolated system 208 and the digital isolation barrier 202 can be configured to communicate digital communication signals bidirectionally between the powered system 206 and the isolated system 208.

Similarly, in other embodiments the power transfer isolation barrier 204 can be configured to transfer power from the isolated system 208 to the powered system 206. The isolated system 208 receives power from the application and transfers the received power to the powered system 206, so that power extraction 210 is superfluous and can be eliminated. The digital isolation barrier 202 can be configured to communicate digital communication signals bidirectionally between the powered system 206 and the isolated system 208.

Referring to FIG. 2 in combination with FIG. 1, the power transfer isolation barrier 204 can comprise one or more transformers 116. The digital isolation barrier 202 can comprise a capacitively-coupled communication channel 118. For example, the digital isolation barrier 202 can form an isolated transmission pathway 218 comprising at least one capacitor 118 and the power transfer isolation barrier 204 can form an isolated power transfer pathway 216 comprising a power transformer 116.

In various embodiments, the digital isolation barrier 202 can be a capacitive isolation barrier, an electrostatic isolation barrier, a transformer isolation barrier, a magnetic isolation barrier, an optical isolation barrier, a thermal isolation barrier, a resistive isolation barrier, a piezoelectric isolation barrier, or any other suitable barrier. The power transfer isolation barrier 204 can be a power transformer, a high-voltage switched-capacitor power circuit, a piezoelectric ceramic power converter, a power transfer device, or other suitable device.

The communication device 200 can further comprise a communication circuit 120 in the isolated system 208 and a communications channel 122 in the powered system 206 that is configured to receive communication signals from a network line 124. An analog communication output port 126 can be coupled to the communications channel 122 in the powered system 206. The communication circuit 120 and the analog communication output port 126 can be configured to convert communication signals into a digital signal and pass the digital signal across the digital isolation barrier 202.

In some embodiments, the communication device 200 can comprise a local powering block in the powered system 206. A power extraction circuit 130 can be coupled to the local powering block in the powered system 206 and configured to extract power from the local powering block and pass the extracted power over the power transfer isolation barrier 204 to power the isolated system 208.

In further embodiments, the communication device 200 can further comprise a Direct Current (DC)/DC converter 140, an analog-to-digital converter that is configured to measure isolated system power output from the DC/DC converter 140. The powered system 206 can be configured to pass feedback control signals over the digital isolation barrier 202 to control DC/DC converter output over the power transfer isolation barrier 204.

The communication device 200 can be implemented in a Power-over-Ethernet (PoE) system in which power is transferred from a line. A power extraction circuit 210 can access line power and transfer the power across the power transfer and isolation barrier 204 to a baseband unit 212. Accordingly, local power or loop power from the line side can supply power for front-end circuits 206 and pass power back to the application circuit 208 through the isolation transformer 204 in a configuration wherein, instead of positioning the isolation point at the analog signal interface, the isolation is shifted to the digital interface 202 and power interface 204.

The secondary circuit 208 is coupled to the digital baseband unit or the isolated unit and supplies the feedback signal in a digital form to control the output voltage of the power extraction circuit 210.

Relocating the isolation point from the analog signal interface to the digital/power interface can improve performance and configuration efficiency for several reasons. For example, power transformers typically do not function well at high frequencies. In contrast, signal transformers can have relatively good signal transfer performance and suitable isolation but for high speed, for example 10 gigabit, communication applications, adequate communication and/or isolation performance are difficult to attain, or size or cost constraints become prohibitive. For example, broadband transformers impose wide bandwidth constraints resulting in physically large circuits, and wide spacing to form a sufficiently high impedance circuit. Broadband transformers also impose a constraint of very low loss, typically calling for implementation of special cores that handle the very low loss.

The illustrative implementation of the communication device 200 includes a power transformer that can operate at low frequencies and at very narrow bandwidth with relatively low linearity and inductance requirements. Separation of the power transformer from signal isolation avoids special signal requirements such as return loss and balance that are imposed for signal transformers. The illustrative architecture moves isolation away from the communications channel 222, avoiding isolation at the analog interface, and positions the isolation at the digital signal isolation barrier 202 and the power isolation barrier 204.

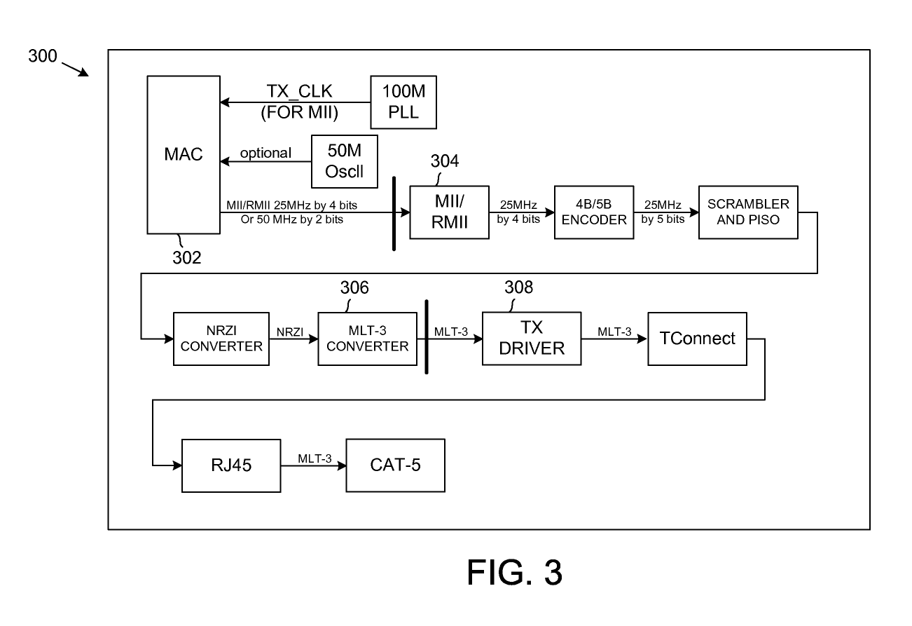

Referring to FIG. 3, a schematic block diagram illustrates an embodiment of a transmitter system 300 in a communication system and shows an example of isolation partitioning lines for a digital isolation barrier 202 in FIG. 2. The digital isolation barrier 202 can be configured as a 10/100/100/100000 Ethernet transmitter system that partitions a communication pathway between the powered system 206 and the isolated system 208 at a partitioning line selected from between a media access control (MAC) block 302 and a media independent interface/reduced media independent interface (MII/RMII) block 304 and from between a digital portion of the transmitter system 306 and an analog transmit (TX) driver 308.

The illustrative 10/100 M transmitter system 300 can include a serializer/deserializer (SERDES) interface. Selected points of isolation can be at the MII/RMII interface 304 which is a highly desirable location, Serial Gigabit Media Independent Interface (SGMII), or at a location between the transmit drive circuitry 308 and the MLT3-coded converter 306 where a three-level signal is present that enables a simple interface.

For an isolation point at the MII/RMII 304, then the SGMII is a serial interface designed to do the MII/RMII interface serially so the SGMII core can be an implementation of the high-speed SERDES interface. If the partition is selected between the MLT-3 converter 306 and the TX driver 308, a more generic serial block can be used.

Referring to FIG. 1 in combination with FIG. 3, the communication isolation barrier 102 can be configured as a 10/100/1000/10000 Ethernet transmitter system that partitions a communication pathway between the secondary circuit 106 and the primary circuit 108 at a partitioning line selected from between a media access control (MAC) block and a media independent interface/reduced media independent interface (MII/RMII) block and from between a MLT-3 converter and a transmit (TX) driver.

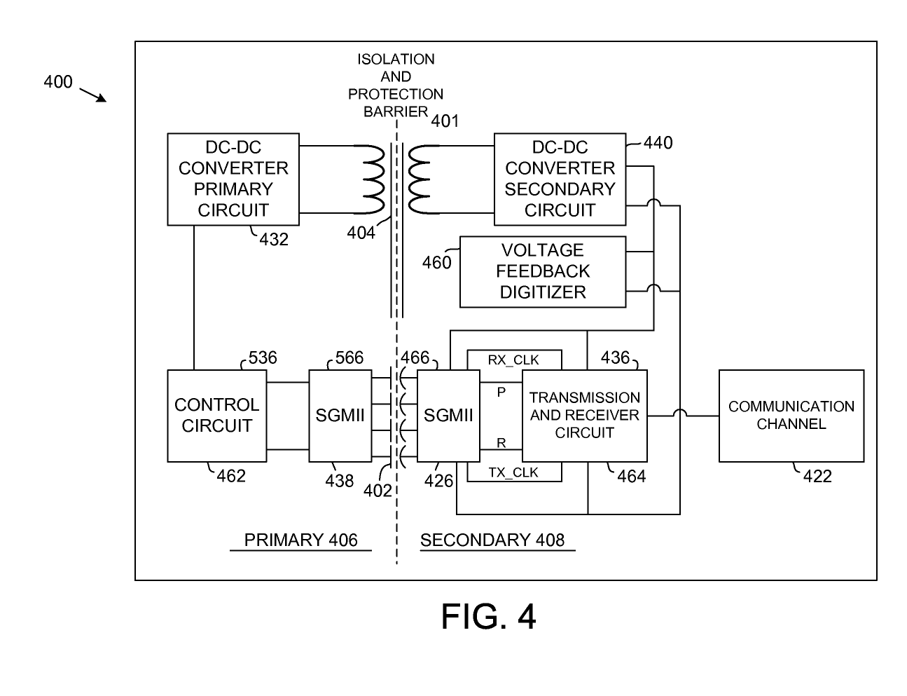

Referring to FIG. 4, a schematic block diagram illustrates an embodiment of a communication system 400 that includes one or more isolation barriers. The isolation barrier comprises a communication isolation barrier 402 and a transformer isolation barrier 404. The illustrative communication system 400 comprises, in addition to the isolation barriers, first 406 and second 408 circuits coupled across the communication isolation barrier 402 and the transformer isolation barrier 404. The first 406 and second 408 circuits are configured to transfer power across the transformer isolation barrier 404 and communicate data across the communication isolation barrier 402 including power feedback data that controls power transfer across the transformer isolation barrier 404.

In various embodiments, the communication isolation barrier 402 can be a capacitive isolation barrier, an electrostatic isolation barrier, a transformer isolation barrier, a magnetic isolation barrier, an optical isolation barrier, a thermal isolation barrier, a resistive isolation barrier, a piezoelectric isolation barrier, or other suitable isolation barrier.

Again referring to FIG. 4, another embodiment depicts an isolation system 400 in an Ethernet application. The isolation system 400 comprises a primary circuit 406 and a secondary circuit 408 that communicate across an isolation barrier 401. The isolation barrier 401 comprises a power transfer isolation barrier 404 and a data communication isolation barrier 402. The secondary circuit 408 comprises a DC-DC converter secondary circuit 440 coupled to the power transfer isolation barrier 404 that receives power transferred through the power transfer isolation barrier 404, a secondary communication interface 426 is coupled to a communication channel 422 for communicating data, and a feedback circuit 460 coupled to the secondary communication interface 426 that receives feedback control data passed through the data communication isolation barrier 402 and controls power transfer according to the feedback control data. The primary circuit 406 comprises a DC-DC converter primary circuit 432 configured to transfer power transferred to the DC-DC converter secondary circuit 440 through the power transfer isolation barrier 404, a primary communication interface 438 configured to communicate data with the secondary communication interface 426 through the data communication isolation barrier 402, and an application controller 462 configured to control various aspects of operation of an application.

The illustrative communication system 400 is partitioned to position the isolation barrier 402 differently from the communication interface between the transmitter and receiver circuit 464 and communication channel 422 which is the common partitioning location for an Ethernet, T1/E1, a High Data Rate Digital Subscriber Line (HDSL (2)) or any other communication interface that implements isolation, protection, common-mode immunity, and minimal common-mode noise emissions. The communication channel 422 interfaces to the transmitter and receiver circuit 464 by a plurality of lines, for example eight lines for Gigabit Ethernet, and the system can be powered from a local power supply so that isolation is convenient at the interface. However, isolating transformers for communication interfaces are expensive, bulky, and large, creating incentive for replacing the communication transformer with an isolating power transformer and isolated data communication interface, while retaining a suitable level of safety and emissions. Accordingly, the illustrative communication system 400 relocates isolation of the communication path to a position that enables usage of less costly and bulky devices. Relocation of isolation and/or separation of power isolation from communication signal isolation can improve performance, reduce board area, and enable higher level of system integration. Fundamentally, the physics underlying transfer power over an isolation barrier is more favorable than for the transfer signal, due primarily, but not limited to, the wideband nature of the communication transformer. Thus, the illustrative communication system 400 implements a front-end circuit 408 that has digital isolation for communication functionality.

The communication system 400 can be implemented with a system architecture that enables system partitioning in which the wideband analog signal on the communication channel 422 can be converted to a high-speed digital signal that is communicated at the isolation barrier 402. The isolation barrier 402 can be implemented as shown in FIG. 4 as capacitors and integrated on silicon and can include very smaller capacitors, for example less than 1 pF, or any suitable size capacitors. The capacitors can be either integrated or discrete. For discrete capacitors, the capacitor size is typically large, for example 5-20 pF. The illustrative isolation barrier in communication system 400 includes the secondary communication interface 426 that forms a high-speed digital interface for communication that is separate from the power transformer isolation barrier 404 which is used to pass and isolate power. A potential drawback to separation of power and communication isolation into separate blocks is difficulty and cost in forming the combination in a single integrated circuit. For example, the communication system 400 can be implemented as a pair of integrated circuit dies in a single package using a standard complementary metal-oxide semiconductor (CMOS) process.

In the illustrative application, the front-end circuitry 408 does not have a power source. Power is supplied from the back-end system 406 and is isolated from the front-end circuitry 408 by a power isolation component 404 such as a transformer, as shown, a capacitor, or any suitable device. A capacitor for usage in power isolation typically is suitably a relative high voltage device such as a switched-capacitor, for example 2 kV power isolation device. Usage of a transformer in the power isolation barrier 404 generally enables greater power transfer than implementations such as capacitors, delta sigma modulators, rectifiers, and other devices. Implementations including a switched-capacitor circuit can attain suitable isolation but limit power for the transceiver, thereby limiting usage to particular applications. One of the limits in high power applications is that a switch-capacitor circuit can generate substantial common-mode noise, and thus a transformer may be the better choice.

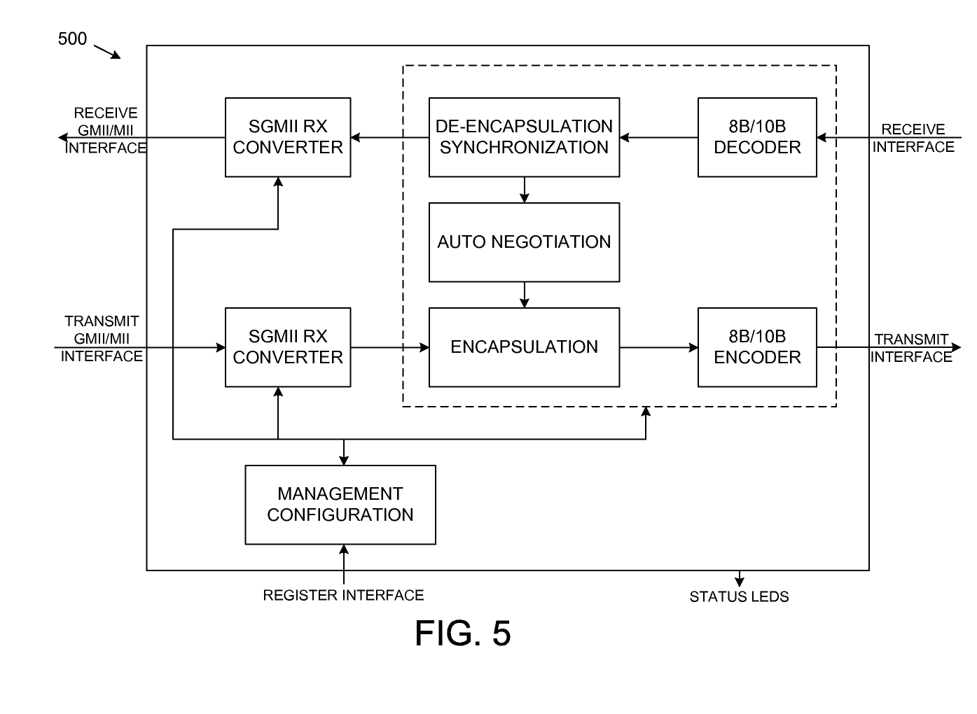

FIG. 5 is a schematic block diagram that depicts an embodiment of a Serial Gigabit Media Independent Interface (SGMII) core 500. Referring to FIG. 4 in combination with FIG. 5, the isolation system 400 can further comprise the power transfer isolation barrier 404 implemented as one or more transformers and the data communication isolation barrier 402 implemented as a capacitive isolation barrier. The secondary communication interface 426 can comprise a transmitter and receiver circuit 464 and a Serial Gigabit Media Independent Interface (SGMII) 466 coupled between the transmitter receiver circuit 464 and the capacitive isolation barrier 402. The primary communication interface 438 can comprise an isolated device control circuit 436 and a Serial Gigabit Media Independent Interface (SGMII) 466 coupled between the isolated device control circuit 436 and the capacitive isolation barrier 402.

In another embodiment, an isolation system 400 can comprise the power transfer isolation barrier 404 implemented as a transformer and the data communication isolation barrier 402 implemented as a capacitive isolation barrier. The secondary communication interface 426 can comprise a transmitter and receiver circuit 464 and a Management Data Input/Output (MDIO) interface coupled between the transmitter receiver circuit 464 and the capacitive isolation barrier 402. The primary communication interface 438 can comprise an isolated device control circuit 436 and a Management Data Input/Output (MDIO) interface coupled between the isolated device control circuit 436 and the capacitive isolation barrier 402.

Referring again to FIG. 4, another embodiment of an isolation system 400 adapted for usage a Power-over-Ethernet application. The isolation system 400 can comprise a primary circuit 408 and a secondary circuit 406 that communicate across an isolation barrier 401. The isolation barrier 401 comprises a power transfer isolation barrier 404 and a data communication isolation barrier 402. The illustrative primary circuit 408 comprises a DC-DC converter primary circuit 440 coupled to the power transfer isolation barrier 404 that is configured for receiving power transferred through the power transfer isolation barrier 404, a primary communication interface 426 coupled to a communication channel 422 for communicating data, and a feedback circuit 460 coupled to the primary communication interface 426 that receives feedback control data passed through the data communication isolation barrier 402 and controls power transfer according to the feedback control data. The secondary circuit 406 comprises a DC-DC converter secondary circuit 440 configured to transfer power transferred to the DC-DC converter primary circuit 432 through the power transfer isolation barrier 404, a secondary communication interface 438 configured to communicate data with the primary communication interface 426 through the data communication isolation barrier 402, and an application controller 462 configured to control an application.

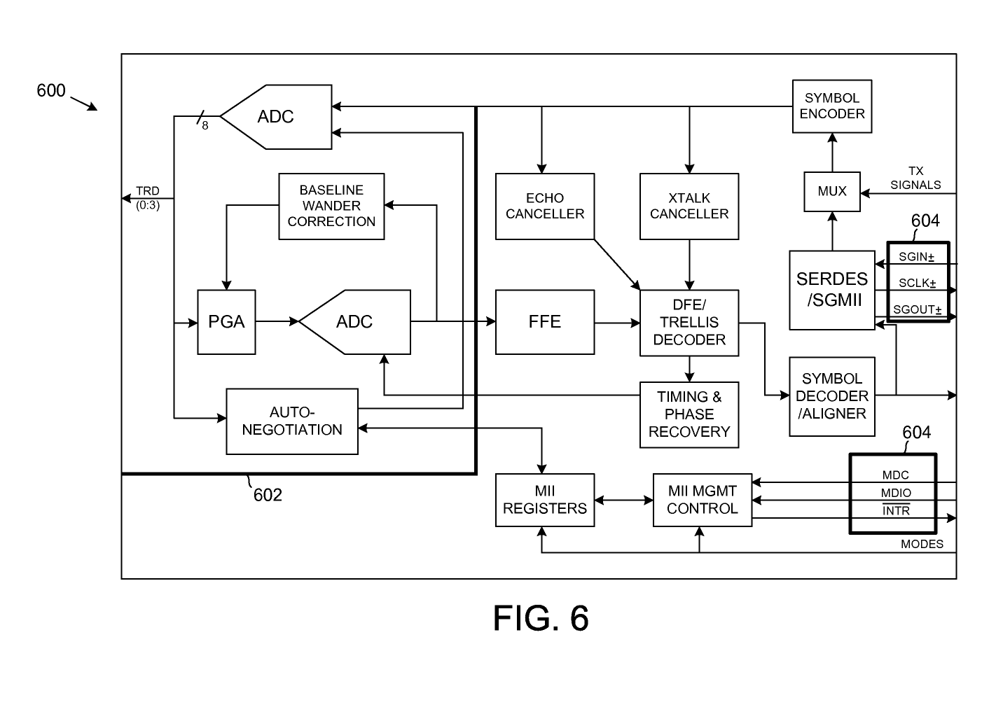

Referring to FIG. 6, a schematic block diagram depicts an embodiment of an Ethernet physical layer (PHY) and examples of locations at which isolation can be implemented. The Ethernet PHY 600 is depicted as an isolated one gigahertz (1 G) PHY. Isolation barrier 602 can be used for transmit (TX), receive (RX), and clock isolation. Each analog to digital converter (ADC) and digital to analog converter (DAC) is isolated, for example for eight lines, along with isolation for clock and control. Accordingly, ten channels are isolated.

Also shown is an isolation barrier 604 for an isolated 1 G PHY with the SGMII isolated.

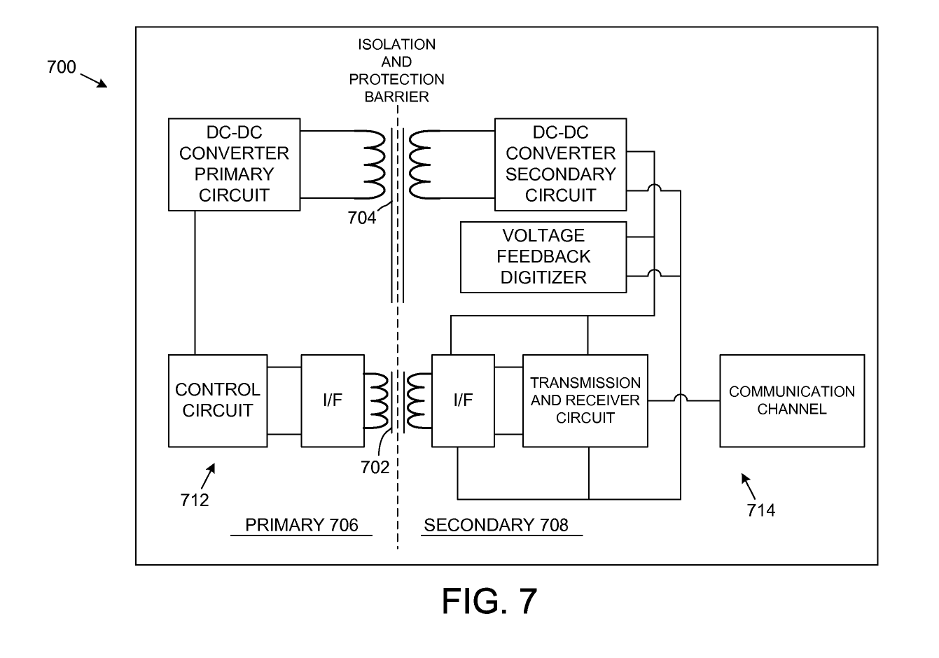

Referring to FIG. 7, a schematic block diagram illustrates an embodiment of a communication system 700 that includes multiple isolation barriers. The illustrative communication system 700 comprises first 702 and second 704 transformer isolation barriers and first 706 and second 708 circuits coupled across the first 702 and second 704 transformer isolation barriers. The first 706 and second 708 transformer isolation barriers are configured to transfer power across the first transformer isolation barrier 702 and communicate data across the second transformer isolation barrier 704 including power feedback data that controls power transfer across the first transformer isolation barrier 702.

In an example embodiment, the communication system 700 can comprise first 710 and second 712 integrated circuit dies that respectively integrate the first 706 and second 708 circuits. The first transformer isolation barrier 702 can include a power transformer and power circuitry. The second transformer isolation barrier 704 can comprise an integrated transformer. The first 710 and second 712 integrated circuit dies, power circuitry in the first transformer isolation barrier 702, and the second 704 transformer isolation barriers can be incorporated in a single package.

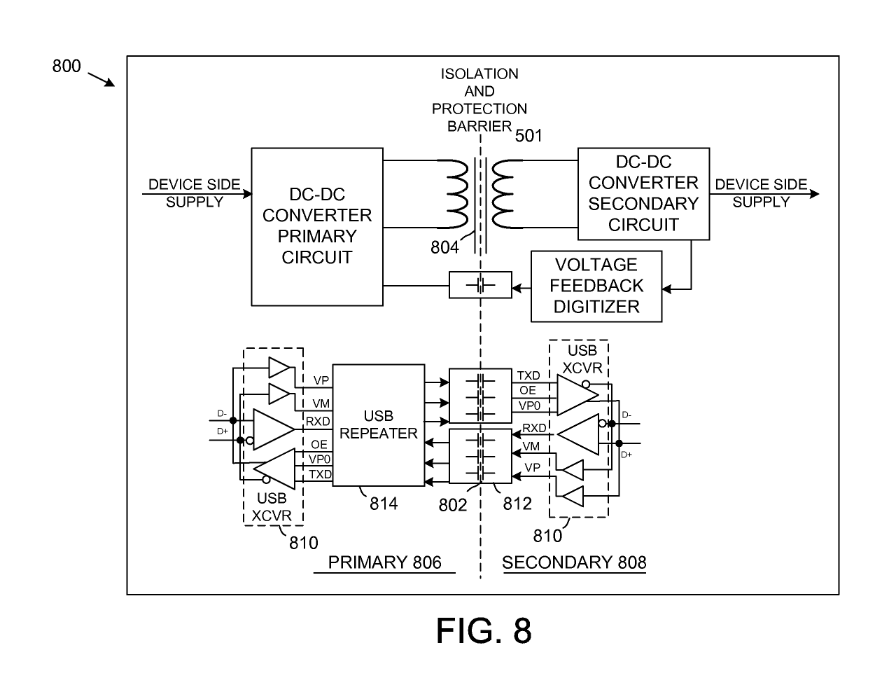

Referring to FIG. 8, a schematic block diagram illustrates another embodiment of a communication system 800 that includes an isolation barrier. The illustrative communication system 800 comprises a primary circuit 806, a secondary circuit 808 adapted to communicate with the primary circuit 806, and an isolation barrier. The isolation barrier comprises a power transfer isolation barrier 804 coupled between the primary circuit 806 and the secondary circuit 808 which is configured to transfer power while maintaining isolation between the primary 806 and secondary 808 circuits, and a Universal Serial Bus (USB) communication isolation barrier 802. The USB communication isolation barrier 802 is distinct from the power transfer isolation barrier 804 and is coupled between the primary circuit 806 and the secondary circuit 808. The USB communication isolation barrier 802 transfers bidirectional USB packet data across the isolation barrier. A USB repeater 814 is used to regenerate the USB data stream before crossing the isolation barrier. In the illustrative communication system 800, the isolation barrier is located at the USB transceiver interface.

In the illustrative embodiment, the communication isolation barrier 802 can be a universal serial bus (USB) port. An isolated USB is traditionally implemented using opto-couplers. The illustrative communication system 800 passes power across the power transformer isolation barrier 804 with the separate communication isolation barrier 802 implemented as a USB port.

The illustrative USB communication isolation barrier 802 includes a pair of three-channel capacitive isolator circuits 812 and a USB line driver block 810 for both the primary circuit 806 and the secondary circuit 808. Each side of the isolation barrier 802 has a USB line driver 810 and a receiver and includes logic that recreates a driver output enable signal. The logic can passively snoop the USB bit stream and determine under all conditions when to reverse the direction of signals on the bus. Primary and secondary sides can be handled differently. A host initiator (primary) detects single-ended signature resistors on the device side (secondary) of the interface and reproduces that resistance on the host side. For the device isolator, the device side presents the correct signature to the host side.

In the USB PHY line drivers 812, USB line states can include transmit 1 (differential), transmit 0 (differential), transmit single-ended VP0 state (D+=0, D−=0), Vp and Vm high impedance, Vp high impedance and Vm pulled high, and Vm high impedance and Vp pulled high. Transmit slew rate depends on data speed.

The USB capacitive isolators 810 control slew rate based on data rate and present a suitable pull-up rate resistance across the isolation barrier 802.

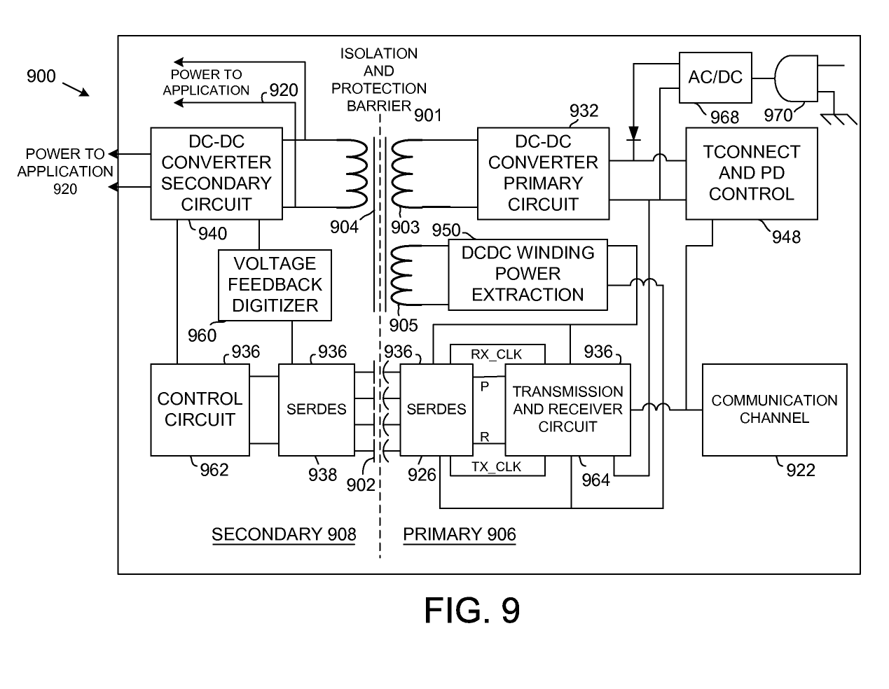

Referring to FIG. 9, a schematic block diagram illustrates an embodiment of a communication system 900 that includes an isolation barrier. The illustrative communication system 900 comprises a transformer isolation barrier 904 and first 906 and second 908 circuits. The transformer isolation barrier 904 comprises a power winding 903 and a feedback winding 905. The first 906 and second 908 circuits are coupled across the transformer isolation barrier 904 and configured to transfer power across the power winding 903 and communicate power feedback data across the feedback winding 905 that controls power transfer across the transformer isolation barrier 904.

The illustrative communication system 900 can further comprise a capacitive isolation barrier 902. The first 906 and second 908 circuits can be coupled across the capacitive isolation barrier 902 and configured to communicate data across the capacitive isolation barrier 902.

Referring again to FIG. 9, another embodiment of an isolation system 900 that can be used in a Power-over-Ethernet application. The illustrative isolation system 900 comprises a primary circuit 906 and a secondary circuit 908 that communicate across an isolation barrier 901. The isolation barrier 902 comprising a power transfer isolation barrier 904 and a data communication isolation barrier 902. The primary circuit 906 can comprise a power extraction circuit 950 that receives power from a power source 970, a DC-DC converter primary circuit 932 coupled to the power extraction circuit 950, and a primary communication interface 926 coupled to a communication channel 922 for communicating data. The secondary circuit 908 can comprise a DC-DC converter secondary circuit 940 configured to received power transferred from the DC-DC converter primary circuit 932 through the power transfer isolation barrier 904, an application power interface 920 coupled to the DC-DC converter secondary circuit 940 configured to supply power to an application, a secondary communication interface 938 configured to communicate data with the primary communication interface 926 through the data communication isolation barrier 902, and a feedback circuit 960 coupled to the secondary communication interface 938 that transmits feedback control data through the data communication isolation barrier 902 and controls power transfer according to the feedback control data.

In some embodiments, the isolation system 900 can further comprise the power transfer isolation barrier 904 can comprise a transformer and the data communication isolation barrier 902 can comprise a capacitive isolation barrier. The power extraction circuit 950 can comprise an Alternating Current (AC)/Direct Current (DC) converter 968 coupled a wall jack 970. The illustrative primary communication interface 926 comprises a transmitter and receiver circuit 964 and a serializer-deserializer (SERDES) 966 coupled between the transmitter receiver circuit 964 and the capacitive isolation barrier 902. The secondary communication interface 938 can comprise an isolated device control circuit 936 and a serializer-deserializer (SERDES) 966 coupled between the isolated device control circuit 936 and the capacitive isolation barrier 902.

Some implementations of the isolation system 900 can also comprise a transformer connect (Tconnect) and power device (PD) control circuit 948 coupled to the DC-DC converter primary circuit 932 and the communication channel 922. The isolation system 900 can also comprise a DC-DC power extraction winding 972 coupled to the Tconnect and PD control circuit 948 coupled to the DC-DC converter primary circuit 932 and the primary communication interface 926.

In some implementations, the isolation system 900 can comprise first and second integrated circuit dies that respectively integrate the primary circuit 906 and the secondary circuit 908.

Some isolation system implementations can further comprise a physical layer (PHY) controller with a third integrated circuit die integrating the PHY controller. The first, second, and third integrated circuit dies, and power circuitry exclusive of transformers in the isolation barrier 901 can be incorporated in a single package.

In still other isolation system implementations, an Ethernet physical layer (PHY) can be used in combination with isolation circuitry and a low voltage power circuit and can be integrated onto third and fourth integrated circuit dies. The first, second, third, and fourth integrated circuit dies, and power circuitry exclusive of transformers in the isolation barrier 901 can be incorporated in a single package including an Ethernet physical layer (PHY), isolation circuit, and low voltage power circuit

In an architecture, for example a p-channel metal oxide semiconductor field effect transistor (PMOS) implementation, in which power is sourced from the line or from the transceiver side, the system can be integrated in three integrated circuit (IC) dies. In an example implementation, a three IC die system can have a high voltage SOI process for usage with a 48 volt supply, a standard PMOS process for the Ethernet circuit, and standard CMOS for the baseband circuitry. Circuitry for the primary circuit 906 can be implemented in two integrated circuit dies, and the secondary circuit 908 can be implemented in one die. The digitizer (DC-DC) in the power extraction circuit 950 that feeds back the information that controls the DC-DC converter 932 can be coupled to an extra winding 905 that can have an architecture similar to the architecture of the digital transformer windings 904. The extra winding 905 can be used to power the transceiver. Additional buck converters can be used to implement a power circuit for the transceiver.

Whether power is delivered across the isolation barrier is from the application side 408 to the primary side 406 as shown in FIG. 4, or delivered from the line side or wall jack side 906 to the application side 908, illustrated in FIG. 9, both use feedback to control the DC-DC converter. The DC-DC converter works with a digitized feedback that uses the high-speed digital serial interface to pass the information back and control the DC-DC converter. In typical usage, the initially unpowered side, upon connection, begins to receive power over the transformer isolation barrier 404, 904, powering the previously unpowered side and increasing the voltage so that the previously inactive communication circuits and voltage feedback digitizer 460, 960 becomes operational to supply digital feedback. The communication isolation barrier 402, 902 that communicates the feedback signal is depicted as four capacitors to form a differential transmit and a differential receive digital channel. Some embodiments may only have a transmitter. Some embodiments may only have a receiver. The illustrative communication isolation barrier 402, 902 with four capacitors forms a transceiver. In some embodiments, a potentially high bandwidth or highly parallel digital interface can be converted into a high-speed digital serial interface, for example by implementing a SGMII interface 466 as shown in FIG. 4, or a SERDES interface 966 depicted in FIG. 9. The SERDES generally has a highpass data content so that AC coupling can be used and can encode the data, either parallel data or serial data, to higher rates to ensure a minimum data density. The transceiver includes a transmit path and a receive path. The transceiver passes embedded DC-DC converter feedback, avoiding the cost of another component, such as an opto-coupler, to control the DC-DC converter. In some embodiments, DC-DC converter circuitry can be integrated using the same process as the transceiver and can be a low voltage process, for example transferring three volts on the primary side to 5 volts on the secondary side, although any suitable voltage by be on either side. The illustrative communication system 400, 900 can be used for transformerless PoE applications.

Although the illustrative embodiments depict a communication isolation barrier 402, 902 that include four differential capacitors, other numbers of capacitors can be implemented depending on the particular system, functionality, and implementation cost. Integrated capacitors can be very cost effective. A six capacitor communication isolation barrier can be implemented to include a pair of capacitors for transmits, a pair for receive, and a pair for clocks. In some configurations and/or embodiments, integrated transformer data coupling can be used as disclosed, for example, in U.S. Pat. Nos. 5,952,849 and 6,873,065.

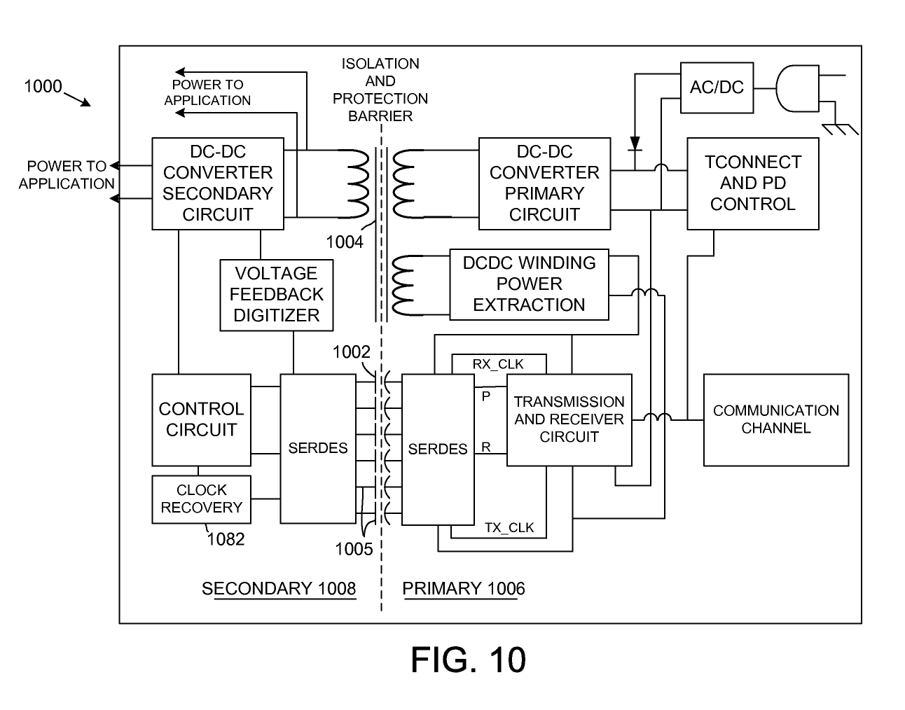

Referring to FIG. 10, a schematic block diagram depicts another embodiment of a communication system 1000 that implements another isolation barrier. The illustrative communication system 1000 comprises a capacitive isolation barrier 1002, a transformer isolation barrier 1004, and first 1006 and second 1008 circuits that are coupled across the capacitive isolation barrier 1002 and the transformer isolation barrier 1002. The first 1006 and second 1008 circuits can be configured to transfer power across the transformer isolation barrier 1004 and communicate data across the capacitive isolation barrier 1002 including a clock signal 1005.

A clock recovery circuit 1082 can be coupled to the first circuit 1006 and/or the second circuit 1008 and operates to recover a transmit clock and a receive clock.

The clock signal 1005 can be passed across an analog to digital (A/D) converter or can be a high-speed data input. The clock signal can also be extracted from the data.

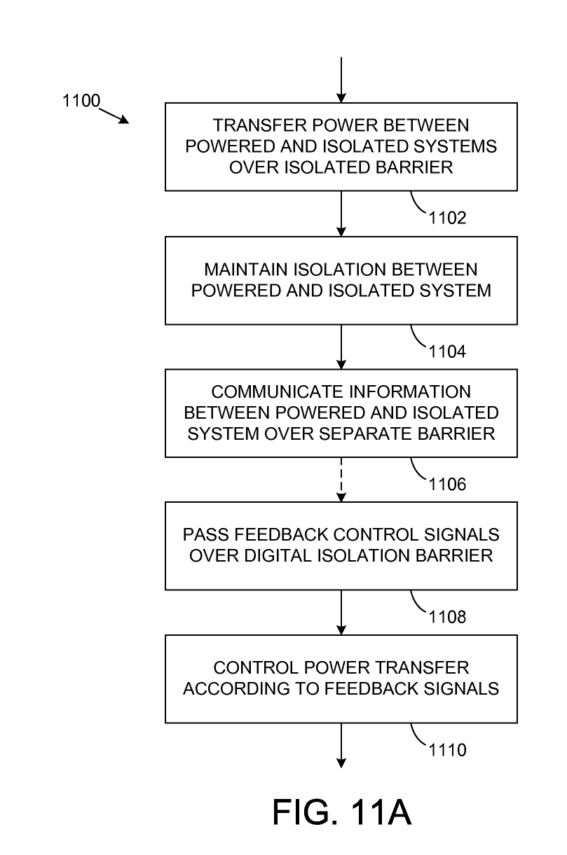

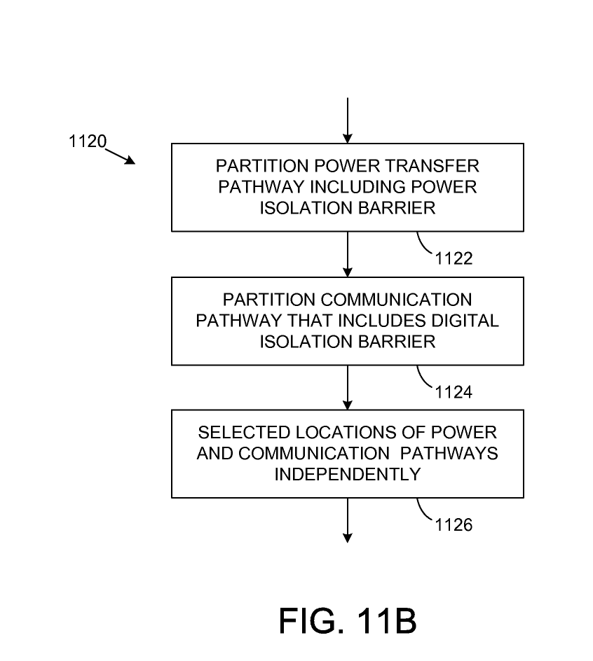

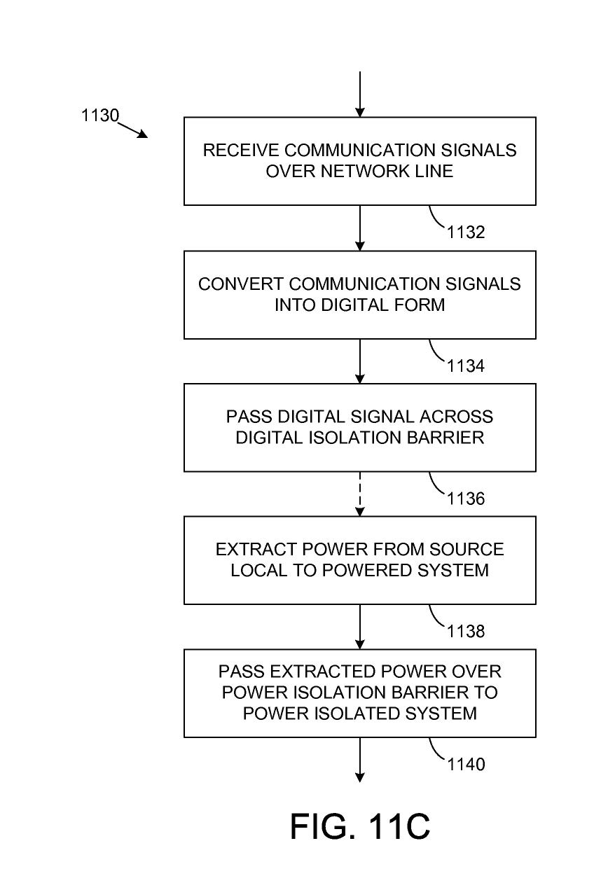

Referring to FIGS. 11A, 11B, and 11C, multiple flow charts illustrate embodiments of a method 1100 for transferring power across an isolation barrier. As shown in FIG. 11A, the method 1100 comprises transferring 1102 power between a powered system and an isolated system across a power transfer isolation barrier while maintaining 1104 isolation between the powered system and the isolated system. Information is bidirectionally communicated 1106 information between the powered system and the isolated system over a digital isolation barrier that is distinct from the power transfer isolation barrier.

In some embodiments, the method 1100 can further comprise passing 1108 feedback control signals over the digital isolation barrier and controlling 1110 transfer of power over the power transfer isolation barrier according to the feedback control signals.

In some implementations and/or conditions, the power can be transferred from the powered system to the isolated system and communicating digital communication signals bidirectionally between the powered system and the isolated system.

Contrariwise, in some implementations and conditions, power can be transferred from the isolated system to the powered system with digital communication signals communicated bidirectionally between the powered system and the isolated system

FIG. 11B illustrates a method 1120 for partitioning power comprising partitioning 1122 a power transfer pathway that includes the power transfer isolation barrier at a first selected location and partitioning 1124 a communication pathway that includes the digital isolation barrier at a second selected location. The first and second selected locations can be selected 1126 mutually independently.

FIG. 11C depicts a method 1130 for communicating over the isolation barrier comprising receiving 1132 communication signals from a network line and converting 1134 the communication signals into a digital signal. The digital signal is passed 1136 across the digital isolation barrier. In some embodiments, the method 1130 can further comprise extracting 1138 power from a power source local to the powered system and passing 1140 the extracted power over the power transfer isolation barrier to power the isolated system.

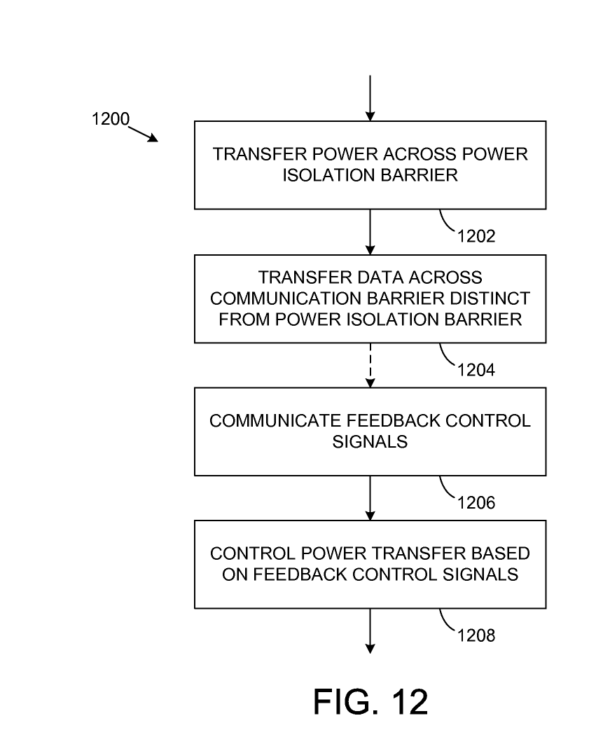

Referring to FIG. 12, a flow chart illustrates an embodiment of a method 1200 for transferring power and information across an isolation barrier comprising transferring 1202 power across a power transfer isolation barrier between a primary circuit and a secondary circuit while maintaining isolation between the primary and secondary circuits, and transferring 1204 data between the powered system and the isolated system across a communication isolation barrier that is distinct from the power transfer isolation barrier.

In some embodiments, the method 1200 can further comprise communicating 1206 feedback control signals in the transferred data and controlling 1208 the transfer of power across the power transfer isolation barrier based on the feedback control signals.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a communication or isolation system are described including several optional implementations for particular portions. Any suitable combination or permutation of the disclosed designs may be implemented.

What is claimed is:

1. A communication system comprising:
a capacitive isolation barrier;
a transformer isolation barrier; and
first and second circuits coupled across the capacitive isolation barrier and the transformer isolation barrier and configured to transfer power across the transformer isolation barrier and communicate data across the capacitive isolation barrier including power feedback data that controls power transfer across the transformer isolation barrier.

2. The communication system according to claim 1 further comprising:
first and second integrated circuit dies respectively integrating the first and second circuits.

3. The communication system according to claim 2 further comprising:
a power circuit; and
the first and second integrated circuit dies, the capacitive isolation barrier, and the power circuit incorporated in a single package.

4. A communication system comprising:
first and second transformer isolation barriers; and
first and second circuits coupled across the first and second transformer isolation barriers and configured to transfer power across the first transformer isolation barrier and communicate data across the second transformer isolation barrier including power feedback data that controls power transfer across the first transformer isolation barrier.

5. The communication system according to claim 4 further comprising:
first and second integrated circuit dies respectively integrating the first and second circuits; and
the second transformer isolation barrier comprising an integrated transformer.

6. The communication system according to claim 5 further comprising:
the second transformer isolation barrier comprising a power transformer and power circuitry;
the first and second integrated circuit dies, the first transformer isolation barrier, and the power circuitry of the second transformer isolation barriers incorporated in a single package.

7. A communication system comprising:
a transformer isolation barrier comprising a power winding and a feedback winding;
a capacitive isolation barrier; and
first and second circuits coupled across the transformer isolation barrier and configured to transfer power across the power winding and communicate power feedback data across the feedback winding that controls power transfer across the transformer isolation barrier, the first and second circuits coupled across the capacitive isolation barrier and configured to communicate data across the capacitive isolation barrier.

8. The communication system according to claim 7 further comprising:
first and second integrated circuit dies respectively integrating the first and second circuits.

9. The communication system according to claim 8 further comprising:
the transformer isolation barrier comprising a power transformer and power circuitry;
the first and second integrated circuit dies, the capacitive isolation barrier, and the power circuitry of the transformer isolation barriers incorporated in a single package.

10. A communication system comprising:
a communication isolation barrier;
a transformer isolation barrier;
first and second circuits coupled across the communication isolation barrier and the transformer isolation barrier and configured to transfer power across the transformer isolation barrier and communicate data across the communication isolation barrier including power feedback data that controls power transfer across the transformer isolation barrier.

11. The communication system according to claim 10 further comprising:
the communication isolation barrier selected from a group consisting of a capacitive isolation barrier, an electrostatic isolation barrier, a transformer isolation barrier, a magnetic isolation barrier, an optical isolation barrier, a thermal isolation barrier, a resistive isolation barrier, and a piezoelectric isolation barrier.

12. The communication system according to claim 10 further comprising:
first and second integrated circuit dies respectively integrating the first and second circuits.

13. The communication system according to claim 12 further comprising:
the first and second integrated circuit dies, and the capacitive isolation barrier incorporated in a single package.

14. An isolation system comprising:
a primary circuit and a secondary circuit that communicate across an isolation barrier;
the isolation barrier comprising a power transfer isolation barrier and a data communication isolation barrier;
the primary circuit comprising a power extraction circuit that receives power from a power source, a Direct Current (DC)-DC converter primary circuit coupled to the power extraction circuit, and a primary communication interface coupled to a communication channel for communicating data;
the secondary circuit comprising a DC-DC converter secondary circuit configured to received power transferred from the DC-DC converter primary circuit through the power transfer isolation barrier, an application power interface coupled to the DC-DC converter secondary circuit configured to supply power to an application, a secondary communication interface configured to communicate data with the primary communication interface through the data communication isolation barrier, and a feedback circuit coupled to the secondary communication interface and configured to transmit feedback control data passed through the data communication isolation barrier and control power transfer according to the feedback control data.

15. The isolation system according to claim 14 further comprising:
the application comprising a Power-over-Ethernet application.

16. The isolation system according to claim 14 further comprising:
the power transfer isolation barrier comprising a transformer;
the data communication isolation barrier comprising a capacitive isolation barrier;
the power extraction circuit coupled to an Alternating Current (AC)/Direct Current (DC) converter coupled a wall jack;
the primary communication interface comprising a transmitter and receiver circuit and a serializer-deserializer (SERDES) coupled between the transmitter receiver circuit and the capacitive isolation barrier; and
the secondary communication interface comprising an isolated device control circuit and a serializer-deserializer (SERDES) coupled between the isolated device control circuit and the capacitive isolation barrier.

17. The isolation system according to claim 16 further comprising:
a transformer connect (Tconnect) and power device (PD) control circuit coupled to the Direct Current (DC)-DC converter primary circuit and the communication channel.

18. The isolation system according to claim 16 further comprising:
a Direct Current (DC)-DC power extraction winding coupled to the transformer connect (Tconnect) and power device (PD) control circuit coupled to the Direct Current (DC)-DC converter primary circuit and the primary communication interface.

19. The communication system according to claim 14 further comprising:
first and second integrated circuit dies respectively integrating the primary circuit and the secondary circuit.

20. The communication system according to claim 19 further comprising:
an Ethernet physical layer (PHY); and
a third integrated circuit die integrating the Ethernet PHY.

21. The communication system according to claim 20 further comprising:
the first, second, and third integrated circuit dies, and the isolation barrier incorporated in a single package.

22. The communication system according to claim 19 further comprising:
an Ethernet physical layer (PHY), isolation circuit, and low voltage power circuit; and
a third and fourth integrated circuit dies integrating the Ethernet PHY, isolation circuit, and low voltage power circuit.

23. An isolation system comprising:
a primary circuit and a secondary circuit that communicate across an isolation barrier;
the isolation barrier comprising a power transfer isolation barrier and a data communication isolation barrier;
the primary circuit comprising a Direct Current (DC)-DC converter primary circuit coupled to the power transfer isolation barrier and configured for transmitting power transferred through the power transfer isolation barrier, a secondary communication interface coupled to a communication channel for communicating data, and a feedback circuit coupled to the secondary communication interface and configured to receive feedback control data passed through the data communication isolation barrier and control power transfer according to the feedback control data; and
the secondary circuit comprising a DC-DC converter secondary circuit configured to transfer power transferred to the DC-DC converter primary circuit through the power transfer isolation barrier, a secondary communication interface configured to communicate data with the primary communication interface through the data communication isolation barrier, and an application controller configured to control an application.

24. The isolation system according to claim 23 further comprising:
the application comprising a 10/100/1000/10000 M Ethernet application.

25. The isolation system according to claim 23 further comprising:
the primary communication interface comprising a transmitter and receiver circuit and a Serial Gigabit Media Independent Interface (SGMII) coupled between the transmitter receiver circuit and the capacitive isolation barrier; and
the secondary communication interface comprising an isolated device control circuit and a Serial Gigabit Media Independent Interface (SGMII) coupled between the isolated device control circuit and the capacitive isolation barrier.

26. The isolation system according to claim 23 further comprising:
the primary communication interface comprising a transmitter and receiver circuit and a Management Data Input/Output (MDIO) interface coupled between the transmitter receiver circuit and the capacitive isolation barrier; and
the secondary communication interface comprising an isolated device control circuit and a Management Data Input/Output (MDIO) interface coupled between the isolated device control circuit and the capacitive isolation barrier.

27. A communication system comprising:
a capacitive isolation barrier;
a transformer isolation barrier;
first and second circuit coupled across the capacitive isolation barrier and the transformer isolation barrier and configured to transfer power across the transformer isolation barrier and communicate data across the capacitive isolation barrier including a clock signal.

28. The communication system according to claim 27 further comprising:
first and second circuits configured to communicate data across the capacitive isolation barrier including power feedback data that controls power transfer across the transformer isolation barrier.

29. The communication system according to claim 27 further comprising:
a clock recovery circuit coupled to the first circuit and/or the second circuit configured to recover a transmit clock and a receive clock.

30. A communication device adapted for communicating across an isolation barrier comprising:
a powered system;
an isolated system configured to bidirectionally communicate with the powered system;
a power transfer isolation barrier configured to transfer power while maintaining isolation between the powered system and the isolated system; and
a digital isolation barrier configured to communicate digital communication signals between the powered system and the isolated system, the power transfer isolation barrier being distinct from the digital isolation barrier.

31. The communication device according to claim 30 further comprising:
the power transfer isolation barrier comprising a transformer.

32. The communication device according to claim 30 further comprising:
the power transfer isolation barrier configured to partition a power transfer pathway between the powered system and the isolated system independently of partitioning of a communication pathway.

33. The communication device according to claim 30 further comprising:
the digital isolation barrier comprising a capacitively-coupled communication channel.

34. The communication device according to claim 30 further comprising:
the digital isolation barrier configured to partition a communication pathway between the powered system and the isolated system independently of partitioning of a power transfer pathway.

35. The communication device according to claim 30 further comprising:
the digital isolation barrier configured as a 10/100/1000/10000 Ethernet transmitter system that partitions a communication pathway between the powered system and the isolated system at a partitioning line selected from between analog-to-digital (ADC) receiver block and a clock and data recover block and from between a digital portion of the transmitter system and an analog transmit (TX) driver.

36. The communication device according to claim 30 further comprising:
a communication circuit in the isolated system;
a communications channel in the powered system configured to receive communication signals from a network line; and
an analog communication output port coupled to the communications channel in the powered system, the communication circuit and the analog communication output port configured to convert communication signals into a digital signal and pass the digital signal across the digital isolation barrier.

37. The communication device according to claim 36 further comprising:
a local powering block in the powered system; and
a power extraction circuit coupled to the local powering block in the powered system and configured to extract power from the local powering block and pass the extracted power over the power transfer isolation barrier to power the isolated system.

38. The communication device according to claim 36 further comprising:
a Direct Current (DC)/DC converter;
an analog-to-digital converter configured to measure isolated system power output from the DC/DC converter; and
the powered system configured to pass feedback control signals over the digital isolation barrier to control DC/DC converter output over the power transfer isolation barrier.

39. The communication device according to claim 30 further comprising:
the digital isolation barrier forming an isolated transmission pathway comprising at least one capacitor; and
the power transfer isolation barrier forming an isolated power transfer pathway comprising a power transformer.

40. The communication device according to claim 30 further comprising:
the digital isolation barrier selected from a group consisting of a capacitive isolation barrier, an electrostatic isolation barrier, a transformer isolation barrier, a magnetic isolation barrier, an optical isolation barrier, a thermal isolation barrier, a resistive isolation barrier, and a piezoelectric isolation barrier; and
the power transfer isolation barrier selected from a group consisting of a power transformer, a high-voltage switched-capacitor power circuit, a piezoelectric ceramic power converter, and a power transfer device.

41. The communication device according to claim 30 further comprising:
the power transfer isolation barrier configured to transfer power from the powered system to the isolated system; and
the digital isolation barrier configured to communicate digital communication signals bidirectionally between the powered system and the isolated system.

42. The communication device according to claim 30 further comprising:
the power transfer isolation barrier configured to transfer power from the isolated system to the powered system; and
the digital isolation barrier configured to communicate digital communication signals bidirectionally between the powered system and the isolated system.

43. A communication system comprising:
a primary circuit;
a secondary circuit adapted to communicate with the primary circuit;
a power transfer isolation barrier coupled between the primary circuit and the secondary circuit configured to transfer power while maintaining isolation between the primary and secondary circuits; and
a communication isolation barrier distinct from the power transfer isolation barrier coupled between the primary circuit and the secondary circuit configured to transfer data between the primary circuit and the secondary circuit.

44. The communication system according to claim 43 further comprising:
the primary circuit comprising:
a communication channel configured for coupling to a network line to communicate information;
a transmission and receiver circuit coupled to the communication channel for transmitting and/or receiving the communicated information;
a digital interface coupled to the transmission and receiver circuit and configured to communicate digital information over the communication isolation barrier; and
a direct current (DC)-DC converter primary circuit coupled to the transmission and receiver circuit and the digital interface, and configured to transfer power over the power transfer isolation barrier;
the secondary circuit comprising:
an application unit configured for transmitting and/or receiving the communicated information;
a digital interface coupled to the application unit and configured to communicate digital information over the communication isolation barrier; and
a direct current (DC)-DC converter secondary circuit coupled to the application unit and the digital interface, and configured to transfer power over the power transfer isolation barrier.

45. The communication system according to claim 44 further comprising:
the secondary circuit further comprising a power connection supplying power from an application system to the direct current (DC)-DC converter secondary circuit; and
the secondary circuit further comprising a feedback digitizer coupled between primary circuit digital interface and the DC-DC converter primary circuit and configured to control power transfer from the primary circuit to the secondary circuit over the power transfer isolation barrier using feedback control.

46. The communication system according to claim 45 wherein the communication system is configured as an Ethernet system.

47. The communication system according to claim 44 further comprising:
the transmission and receiver circuit and digital interface in the primary circuit, and the application unit and digital interface in the secondary circuit configured to pass feedback control signals over the digital isolation barrier that control transfer of power over the power transfer isolation barrier.

48. The communication system according to claim 44 further comprising:
the primary circuit further comprising:
a power connection supplying power to the direct current (DC)-DC converter primary circuit;
a Tconnect and powered device (PD) controller coupled to the DC-DC converter primary circuit; and
a power extraction circuit coupled to the primary circuit digital interface and configured to controllably transfer additional power over the power transfer isolation barrier; and
the secondary circuit further comprising:
a power connection supplying power from the direct current (DC)-DC converter secondary circuit to an application system; and
a feedback digitizer coupled between secondary circuit digital interface and the DC-DC converter secondary circuit and configured to control power transfer over the power transfer isolation barrier using feedback control.

49. The communication system according to claim 48 wherein the communication system is configured as a Power-over-Ethernet (PoE) system.

50. The communication system according to claim 43 further comprising:
the primary circuit and secondary circuit digital interfaces selected from a group consisting of a serializer/deserializer (SERDES) interface or a Serial Gigabit Media Independent Interface (SGMII).

51. The communication system according to claim 43 further comprising:
the communication isolation barrier configured as a 10/100/1000/10000 Ethernet transmitter system that partitions a communication pathway between the powered system and the isolated system at a partitioning line selected from between and from between a MLT-3 converter and a transmit (TX) driver.

52. The communication system according to claim 43 further comprising:
the communication isolation barrier forming an isolated transmission pathway comprising at least one capacitor; and
the power transfer isolation barrier forming an isolated power transfer pathway comprising a power transformer.

53. The communication system according to claim 43 further comprising:
the communication isolation barrier selected from a group consisting of a capacitive isolation barrier, an electrostatic isolation barrier, a transformer isolation barrier, a serializer/deserializer (SERDES) isolation barrier, a magnetic isolation barrier, an optical isolation barrier, a thermal isolation barrier, a resistive isolation barrier, and a piezoelectric isolation barrier; and
the power transfer isolation barrier selected from a group consisting of a power transformer, a high-voltage switched-capacitor power circuit, a piezoelectric ceramic power converter, and a power transfer device.

54. The communication system according to claim 43 further comprising:
the power transfer isolation barrier configured to transfer power from the primary circuit to the secondary circuit; and
the communication isolation barrier configured to communicate digital communication signals bidirectionally between the primary circuit and the secondary circuit.

55. The communication system according to claim 43 further comprising:
the power transfer isolation barrier configured to transfer power from the primary circuit to the secondary circuit; and
the communication isolation barrier configured to communicate digital communication signals bidirectionally between the primary circuit and the secondary circuit.

56. A method for transferring power across an isolation barrier comprising:
transferring power between a powered system and an isolated system across a power transfer isolation barrier while maintaining isolation between the powered system and the isolated system; and
bidirectionally communicating information between the powered system and the isolated system over a digital isolation barrier that is distinct from the power transfer isolation barrier.

57. The method according to claim 56 further comprising:
partitioning a power transfer pathway that includes the power transfer isolation barrier at a first selected location;
partitioning a communication pathway that includes the digital isolation barrier at a second selected location; and
selecting the first and second selected locations mutually independently.

58. The method according to claim 56 further comprising:
receiving communication signals from a network line;
converting communication signals into a digital signal; and
passing the digital signal across the digital isolation barrier.

59. The method according to claim 58 further comprising:
extracting power from a power source local to the powered system; and
passing the extracted power over the power transfer isolation barrier to power the isolated system.

60. The method according to claim 56 further comprising:
passing feedback control signals over the digital isolation barrier; and
controlling transfer of power over the power transfer isolation barrier according to the feedback control signals.

61. The method according to claim 56 further comprising:
transferring power from the powered system to the isolated system; and
communicating digital communication signals bidirectionally between the powered system and the isolated system.

62. The method according to claim 56 further comprising:
transferring power from the isolated system to the powered system; and
communicating digital communication signals bidirectionally between the powered system and the isolated system.

63. A method for transferring power and information across an isolation barrier comprising:
transferring power across a power transfer isolation barrier between a primary circuit and a secondary circuit while maintaining isolation between the primary and secondary circuits; and
transferring data between the powered system and the isolated system across a communication isolation barrier that is distinct from the power transfer isolation barrier.

64. The method according to claim 63 further comprising:
communicating feedback control signals in the transferred data; and
controlling the transfer of power across the power transfer isolation barrier based on the feedback control signals.

65. A method for transferring power and information across an isolation barrier comprising:
transferring power across a power transfer isolation barrier between a primary circuit and a secondary circuit while maintaining isolation between the primary and secondary circuits;
transferring feedback control signals between the powered system and the isolated system across a communication isolation barrier that is distinct from the power transfer isolation barrier; and
controlling the transfer of power across the power transfer isolation barrier based on the feedback control signals.

66. A communication system comprising:
a primary circuit;
a secondary circuit adapted to communicate with the primary circuit;
a power transfer isolation barrier coupled between the primary circuit and the secondary circuit configured to transfer power while maintaining isolation between the primary and secondary circuits; and
a Universal Serial Bus (USB) communication isolation barrier distinct from the power transfer isolation barrier coupled between the primary circuit and the secondary circuit configured to communicate bidirectional USB packet data between the primary circuit and the secondary circuit.

67. The system according to claim 66 further comprising:
a Universal Serial Bus (USB) repeater coupled to the USB communication isolation barrier configured to regenerate a data stream before passing across the isolation barrier.

68. The system according to claim 66 further comprising:
the power transfer isolation barrier and the Universal Serial Bus (USB) isolation barrier integrated into an integrated Universal Serial Bus (USB) system, the integrated USB isolation barrier comprising at least one USB transceiver, a USB repeater, and at least one isolator.

69. An isolation system comprising:
a primary circuit and a secondary circuit that communicate across an isolation barrier;
the isolation barrier comprising a power transfer isolation barrier and a data communication isolation barrier;
the primary circuit comprising a Direct Current (DC)-DC converter primary circuit coupled to the power transfer isolation barrier and configured for receiving power transferred through the power transfer isolation barrier, a primary communication interface coupled to a communication channel for communicating data, and a feedback circuit coupled to the primary communication interface and configured to receive feedback control data passed through the data communication isolation barrier and control power transfer according to the feedback control data; and
the secondary circuit comprising a DC-DC converter secondary circuit configured to transfer power to the DC-DC converter primary circuit through the power transfer isolation barrier, a secondary communication interface configured to communicate data with the primary communication interface through the data communication isolation barrier, and an application controller configured to control an application.

70. The isolation system according to claim 69 further comprising:
the application comprising a Power-over-Ethernet application.

71. The isolation system according to claim 69 further comprising:
the power transfer isolation barrier comprising a transformer;
the data communication isolation barrier comprising a capacitive isolation barrier;
the primary communication interface comprising a transmitter and receiver circuit and a Serial Gigabit Media Independent Interface (SGMII) coupled between the transmitter receiver circuit and the capacitive isolation barrier; and
the secondary communication interface comprising an isolated device control circuit and a SGMII coupled between the isolated device control circuit and the capacitive isolation barrier.
